(19) United States
(12) Patent Application Publication
(10) Pub. No.: US 2024/0322458 A1
(43) Pub. Date: Sep. 26, 2024

(54) LEAD TERMINAL HAVING A MODULAR DESIGN, AND MODULAR SYSTEM

(71) Applicant: WAGO Verwaltungsgesellschaft mbH, Minden (DE)

(72) Inventor: Henry STOLZE, Bad Frankenhausen (DE)

(73) Assignee: WAGO Verwaltungsgesellschaft mbH, Minden (DE)

(21) Appl. No.: 18/735,149

(22) Filed: Jun. 5, 2024

Related U.S. Application Data
(63) Continuation of application No. PCT/EP2022/084594, filed on Dec. 6, 2022.

(30) Foreign Application Priority Data
Dec. 6, 2021 (DE) 10 2021 132 042.9

(51) Int. Cl. H01R 4/48

(52) U.S. Cl. CPC H01R 4/4828; H01R 4/484

(57) ABSTRACT

A lead terminal that has a modular design, and that has at least one connection module and a plug-in module. The plug-in module being separate from the connection module.

This nonprovisional application is a continuation of International Application No. PCT/EP2022/084594, which was filed on Dec. 6, 2022, and which claims priority to German Patent Application No. 10 2021 132 042.9, which was filed in Germany on Dec. 6, 2021, and which are both herein incorporated by reference.

### BACKGROUND OF THE INVENTION

### Field of the Invention

The invention relates to a lead terminal having a modular design, including at least one connection module and a plug-in module that is separate from the connection module. For example, an electrical plug connector having a modular design is known from WO 2019/192911 A1, which is incorporated herein by reference.

### SUMMARY OF THE INVENTION

It is therefore an object of the invention to provide a universally usable lead terminal having a modular design, which may variably be made up of different modules (connection module, plug-in module). Furthermore, a modular system for forming different lead terminals that are configurable as needed is provided.

This object is achieved by a lead terminal that has, for example, the following features: a connection module that has at least one first spring-loaded clamping connection with a first clamping spring for connecting a first electrical conductor by means of elastic force, and a first insulation material housing that at least partially encloses the first clamping spring, the plug-in module has at least one second spring-loaded clamping connection with a second clamping spring for connecting a second electrical conductor by means of elastic force, and a second insulation material housing that at least partially encloses the second clamping spring, the first insulation material housing has at least one first form-fit coupling element, the second insulation material housing has at least one second form-fit coupling element that is designed as a mating piece for the first form-fit coupling element, so that the second insulation material housing is fastenable to the first insulation material housing via a form-fit coupling between the first form-fit coupling element and the second form-fit coupling element, the first clamping spring has a first clamping leg for clamping the first electrical conductor to a first clamping point situated in the first insulation material housing, and a first contact leg via which the first clamping spring is supported with respect to the clamping force of the first clamping leg, the first insulation material housing has a first side wall situated on the side of the first clamping leg facing away from the first contact leg, a first opening being situated in the first side wall, the second insulation material housing, at a second side wall facing the first side wall, has a second opening that is aligned with the first opening, the lead terminal has a shared busbar, which in the connected state of the connection module to the plug-in module extends from the first spring-loaded clamping connection, through the first and the second openings, to the second spring-loaded clamping connection, the busbar having a first clamping section which together with the first clamping leg forms the first clamping point.

The invention has the advantage that the lead terminal, due to its modular design concept, may be assembled by the user as needed; i.e., in different examples may be put together from various connection modules and plug-in modules. For example, there may be plug-in modules for connecting a conventional electrical conductor, which has insulation, and within the insulation has a conductor wire or multiple conductor wires. Plug-in modules are also conceivable which may be designed specifically for connecting round pins or flat plugs as second electrical conductors. The individual modules, i.e., the connection modules and the plug-in modules, may advantageously be automatedly manufactured in a cost-effective manner, and the individual variants of the lead terminal may be snapped together from the various modules as needed.

The invention thus allows a relatively simple and cost-effective design of the individual modules by using proven components and design principles. Due to the modular design, a wide variety of variants of lead terminals is easily implementable with little outlay for warehousing. By use of the available modules, single-pole as well as multi-pole lead terminals, for example connection clamps, through clamps, or box clamps, may be implemented.

Good current flow may be ensured due to the shared busbar, which connects the spring-loaded clamping connections of the connection module and the plug-in module to one another. The shared busbar may have a multi-part design made up of various busbar pieces, or may have a one-part design made up of only one busbar piece.

At the free end of the first clamping leg, the first clamping spring may have a clamping edge via which the first electrical conductor may be clamped to the first clamping point in a particularly secure manner. The first clamping spring may have a first spring bend via which the first clamping leg is connected to the first contact leg. The second clamping spring may have a second clamping leg for clamping the second electrical conductor to a second clamping point situated in the second insulation material housing, and a second contact leg which supports the second clamping spring against the clamping force of the second clamping leg. At the free end the second clamping leg may have a clamping edge via which the second electrical conductor may be clamped to the second clamping point in a particularly secure manner. The second clamping spring may have a second spring bend via which the second clamping leg is connected to the second contact leg.

The first spring-loaded clamping connection may be designed as a direct plug-in connection into which the first electrical conductor is directly insertable without actuating the first clamping leg, and is clampable in this way. The second spring-loaded clamping connection may be designed as a direct plug-in connection into which the second electrical conductor is directly insertable without actuating the second clamping leg, and is clampable in this way.

The first and/or the second form-fit coupling element may be designed as a detent element, for example. The first and second form-fit coupling elements may also be designed in the manner of a tongue and groove connection or designed similarly to a dovetail connection.

The busbar in the unassembled state of the connection module with the plug-in module can be fastened to the connection module or to the plug-in module, and with a busbar section extends out of the particular insulation material housing. Accordingly, the busbar, at least in one of the modules, may already be preassembled. It is thus easy and reliably possible for the user to couple the connection module to the plug-in module and thus produce a functional lead terminal without the user having to insert the busbar separately. In the process, the busbar section protruding from the particular insulation material housing is introduced into the respective other insulation material housing. The busbar section protruding from the insulation material housing may be, for example, a clamping section for connecting the first or second electrical conductor, for example the first clamping section or second clamping section explained below.

The busbar can have a curved section, adjoining the first clamping section, in which the busbar merges in a curved manner, directly or via at least one further section of the busbar, into a second clamping section which with a second clamping leg of the second clamping spring forms a second clamping point for clamping the second electrical conductor. As a result, the busbar has a compact design and allows the connection module to be easily plugged together with the plug-in module to form the lead terminal; upon assembly, the connection between the first spring-loaded clamping connection and the second spring-loaded clamping connection is automatically established via the busbar.

The second clamping section can be situated essentially and/or predominantly in parallel to the first clamping section. This is also necessary for a compact design of the lead terminal. The busbar may have, for example, a U shape in the side view.

The first form-fit coupling element can be situated in the region of the first side wall, and/or the second form-fit coupling element is situated in the region of the second side wall. This allows a reliable, easy-to-use mechanical connection of the connection module to the plug-in module.

The connection module, as a further component, can have an actuating element, in particular an actuating lever or a push actuator, via which the first clamping leg is deflectable by manual actuation in order to open the first clamping point. This allows the first clamping point to be easily opened without an additional tool. Due to its deflection, the clamping leg is moved away from the first clamping section of the busbar. The actuating lever may be designed as a swivelable actuating lever, for example.

The first side wall may rest against the second side wall, at least in a first subarea. The first and second insulation material housings may thus be reliably coupled to one another without play.

The second insulation material housing can be fastenable to the first insulation material housing by a displacement movement in which the second insulation material housing is displaced at an acute angle relative to the first insulation material housing, and a subsequent swivel movement in which the second side wall is oriented predominantly in parallel to the first side wall, via the form-fit coupling between the first form-fit coupling element and the second form-fit coupling element. This allows particularly advantageous installation of the lead terminal by the user. After the connection module is coupled to the plug-in module, a robust unit is provided which can be used similarly as for any lead terminal having a standard (nonmodular) design.

A further advantage is that for combining the connection module with the plug-in module, little or no actuation is necessary for the particular clamping leg. In particular, the actuating element of the connection module needs to be actuated only very slightly in order to fasten the plug-in module thereto, and at the same time, to establish the connection to the busbar.

The first side wall may not rest against the second side wall, at least in a second subarea, and in the second subarea a first open space, in particular a wedge-shaped first open space, is formed between the first and second side walls. A simple technical implementation option of the above-mentioned type for connecting the first and second insulation material housings is thus provided, in particular due to the combined displacement movement and swivel movement.

The first insulation material housing can be made up of at least two separate housing parts that are coupleable to one another, and/or the second insulation material housing is made up of at least two separate housing parts that are coupleable to one another. In this way, the particular spring-loaded clamping connection may be easily and quickly inserted into the associated insulation material housing and fastened, in particular via automated assembly.

The first insulation material housing can have a first conductor insertion opening for introducing the first electrical conductor, and the second insulation material housing has a second conductor insertion opening for introducing the second electrical conductor, the first conductor insertion opening being situated on the side of the lead terminal facing away from the second conductor insertion opening. An advantageous connection clamp similar to a through clamp is thus provided.

The first insulation material housing can have a first main housing part with an assembly opening for inserting the first spring-loaded clamping connection into the first main housing part, and a first cover part for at least partially closing the assembly opening, the first cover part being insertable into the first main housing part from the side opposite the first side wall. In particular, a preassembled unit that contains the first spring-loaded clamping connection and optionally the actuating element may thus be easily inserted into the main housing part. The stated preassembled unit may also already contain the first cover part as a component.

The second insulation material housing can have a second main housing part with an assembly opening for inserting the second spring-loaded clamping connection into the second main housing part, and a second cover part for at least partially closing the assembly opening, the second cover part being insertable into the second main housing part from a side facing away from the second conductor insertion opening. This allows a particularly compact design of the plug-in module, in particular a very flat plug-in module. In addition, the second spring-loaded clamping connection in a preassembled state may be easily inserted into the main housing part.

The second side wall may be formed by a wall section of the second main housing part facing the first side wall, and a wall section of the second cover part, the second opening being formed between the wall sections. The second opening may have a relatively short design, for example having a length of less than 30% or less than 20% of the length of the second side wall or of the sum of the lengths of the mentioned wall sections.

A support contour that protrudes from the second side wall in the direction of the first insulation material housing and that is configured for supporting the busbar and/or for supporting the first insulation material housing on the second insulation material housing is situated at the second side wall. By means of such a support contour, opposing conductor tensile forces that occur at the first electrical conductor and second electrical conductor, for example, may be intercepted, for example in that the support contour supports the plug-in module on the insulation material housing of the connection module. In addition, the contacts may be protected from stresses, in particular during the assembly process. The support contour may, for example, have a section that extends away from the second side wall and that runs obliquely or in a ramp-shaped manner with respect to the surface of the second side wall. A busbar section that protrudes from the second insulation material housing may thus be inserted into the first insulation material housing toward the first clamping point in a particularly targeted manner. The support contour may advantageously extend through the first opening or at least into the first opening.

Moreover, the object stated at the outset is achieved by a modular system for forming different lead terminals that are configurable as needed, the system including a plurality of connection modules having the same or different designs, and a plurality of plug-in modules of the above-mentioned type having the same or different designs; a single-pole or multi-pole lead terminal may be formed by joining one or more connection modules with one or more plug-in modules of the system, at the user's option. The above-mentioned advantages may be achieved in this way as well.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a lead terminal in a lateral sectional illustration,

FIGS. 2 and 3 show an actuating element in various perspective views,

FIG. 4 shows a first spring-loaded clamping connection in a perspective view,

FIG. 5 shows a second spring-loaded clamping connection in a perspective view,

FIG. 6 shows an assembly that includes the first spring-loaded clamping connection, in a lateral sectional illustration,

FIG. 7 shows the lead terminal according to FIG. 1 when carrying out the connection operation between the connection module and the plug-in module,

FIG. 8 shows the connection module in a perspective view,

FIG. 9 shows the plug-in module in a perspective view, and

FIG. 10 shows the lead terminal that is formed from the connection module according to FIG. 8 and the plug-in module according to FIG. 9, in a perspective view.

### DETAILED DESCRIPTION

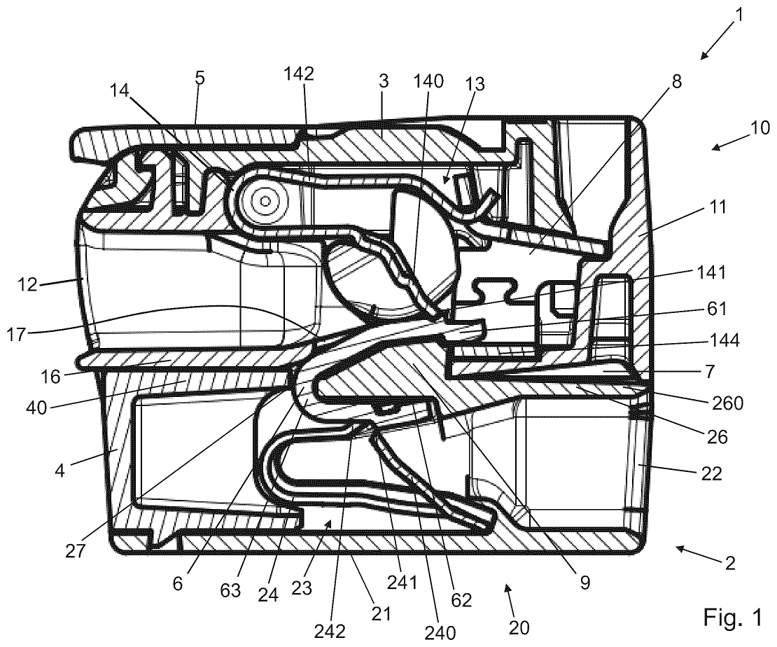

The lead terminal illustrated in FIG. 1 has a connection module 1 and a plug-in module 2 situated therebelow. The connection module 1 is mechanically coupled to the plug-in module 2 via form-fit coupling elements, as explained in greater detail below with reference to other illustrations.

The connection module 1 has a first insulation material housing 10, which in this case has a two-part design with the following housing parts: the first main housing part 11 and the first cover part 3. A first spring-loaded clamping connection 13 is situated in the first insulation material housing 10. The first spring-loaded clamping connection 13 has a first clamping spring 14. The first clamping spring 14 has a first clamping leg 140 for clamping a first electrical conductor to a first clamping point 141, and a first contact leg 142. The first contact leg 142 supports the first clamping spring 14 against the clamping force of the first clamping leg 140. For this purpose, the first contact leg 142 is suspended in a holding frame 8. The holding frame 8 extends from an upper region, at which the first contact leg 142 is suspended, to a lower busbar support region 144 on which a busbar 6 rests.

The busbar 6 has a first clamping section 61 and a curved section 63, adjoining the first clamping section 61, in which the busbar 6 has a curved design and merges into a second clamping section 62 of the busbar 6. The clamping leg 140 is supported on the busbar support region 144 via the busbar 6 or via the first clamping section 61 thereof, or when the first electrical conductor is clamped there, is indirectly supported via the first electrical conductor.

The first insulation material housing 10 has a first conductor insertion opening 12 through which the first electrical conductor for the first clamping point 141 may be introduced into the first insulation material housing 10. In addition, a swivelable actuating lever which may be manually actuated at the outer side of the first insulation material housing 10, for example at the housing side described above at which the first cover part 3 is situated, is present as an actuating element 5 for actuating the first clamping leg 140.

The plug-in module 2 has a second insulation material housing 20, which has a two-part design with the following housing parts: the second main housing part 21 and the second cover part 4. A second spring-loaded clamping connection 23 is situated in the second insulation material housing 20, and has a second clamping spring 24 for connecting a second electrical conductor to a second clamping point 241 by means of elastic force. The second insulation material housing 20 has a second conductor insertion opening 22 through which the second electrical conductor for the second clamping point 241 may be introduced into the second insulation material housing 20. The second clamping spring 24 has a second clamping leg 240, which with a second clamping section 62 of the busbar 6 forms the second clamping point 241. In addition, the second clamping spring 24 has a second contact leg 242 that is suspended on the side of the second clamping section 62 of the busbar 6 facing away from the second clamping leg 240.

The first insulation material housing 10 has a first side wall 16 situated on the side of the first clamping leg 140 facing away from the first contact leg 142. The first side wall 16 thus directly faces the second insulation material housing 20. A first opening 17 is situated in the first side wall 16.

At a second side wall 26 facing the first side wall 16, the second insulation material housing 20 has a second opening 27 that is at least partially aligned with the first opening 17. In the illustrated example, the second side wall 26 is formed by a wall section 260 of the second main housing part 21 and a wall section 40 of the second cover part 4, with the second opening 27 being formed between the wall sections 40, 260. It is apparent that the busbar 6 extends from the first clamping point 141, through the first opening 17 and the second opening 27, to the second clamping point 241.

The first side wall 16 rests against the second side wall 26 or the wall section 40 at least in a subarea, for example the area of the wall section 40 illustrated at the left. A first open space 7 is provided between the first side wall 16 and the second side wall 26, in the area illustrated at the right. This first open space 7 may be advantageously used for installing the connection module 1 at the plug-in module 2, as explained in greater detail below.

Situated at the second side wall 26, in particular at the wall section 260, is a support contour 9 which protrudes from the second side wall 26 in the direction of the first insulation material housing 10, and which is configured for supporting the busbar 6 and/or for supporting the first insulation material housing 10 on the second insulation material housing 20.

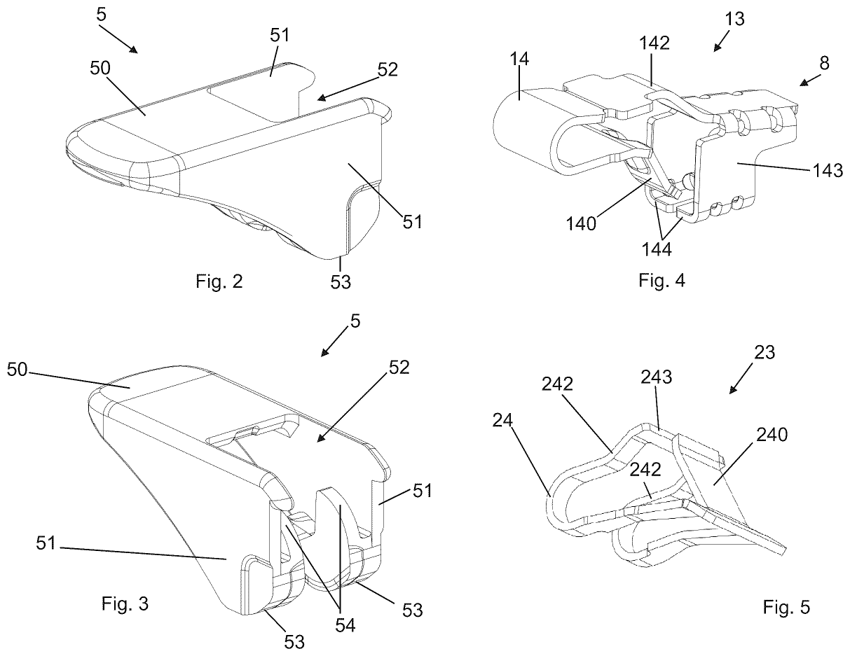

One advantageous design of the actuating element 5 is explained with reference to FIGS. 2 and 3. The actuating element 5 may have a manual actuating region 50 at which the actuating element may be gripped and manually operated by the user. The actuating element 5 has two guide walls 51 that are situated essentially at right angles to the manual actuating region 50 and predominantly in parallel to one another, between which a second open space 52 is formed. For example, the manual actuating region 50 may extend over only a partial section of the longitudinal extension of the guide walls 51, so that in a rear region the second open space 52 extends to the upper edge of the guide walls 51 facing the manual actuating region 50.

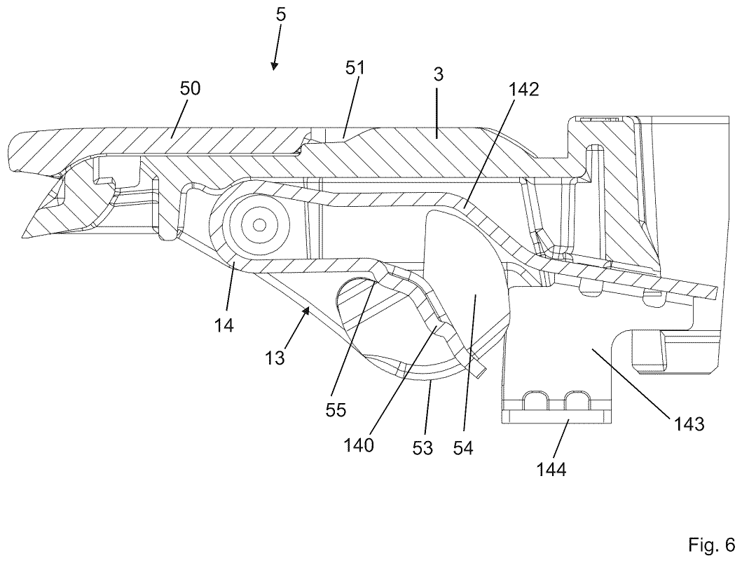

At the end facing away from the manual actuation region 50, the guide walls 51 have respective bearing regions 53 which may have a convex shape, for example an arc shape, at least in areas. Additional inner walls 54 may extend from the bearing regions 53, in parallel to the respective guide wall. On each side of the actuating element 5, an additional accommodation space is thus provided, between the guide wall 51 and the associated inner wall 54, which may be used, for example, to accommodate an inner housing wall of the first insulation material housing 10. A spring entrainment element 55 may be integrally formed on one or both inner walls 54, via which the first clamping leg 140 is deflected during a swivel movement of the actuating element 5 (discernible in FIG. 6).

FIG. 4 shows a design of the first clamping spring 14 that is modified compared to the example in FIG. 1. In this case, the first clamping spring 14 has a one-part design with the holding frame 8, for example in that the contact leg 142 is reformed into such a holding frame 8 over an extended region that curves toward the first clamping leg 140 on both sides. The busbar support region 144 is hereby connected to the first contact leg 142 on both sides via vertical walls 143 of the holding frame 8.

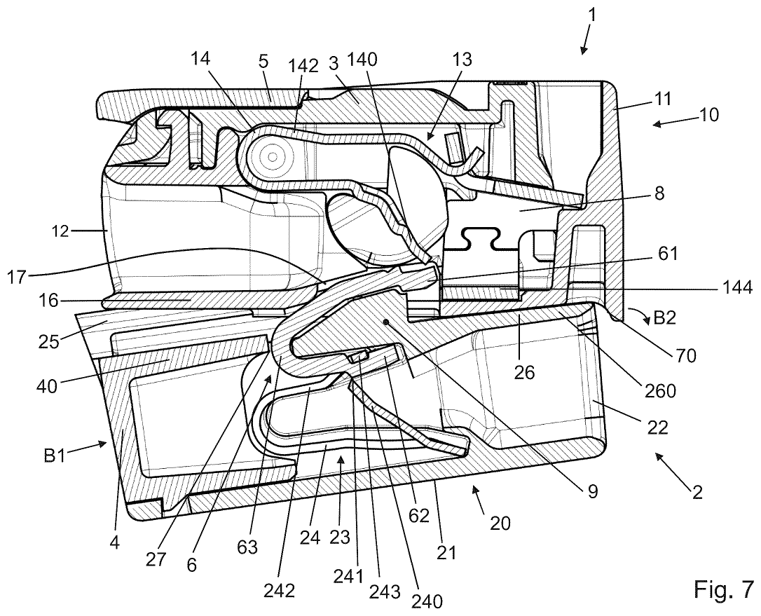

FIG. 5 shows an advantageous design of the second spring-loaded clamping connection 23 with the second clamping spring 24. The second clamping spring 24 may be designed as a so-called push wire connector, for example made of a sheet metal part from which the second clamping leg 240 is exposed via a stamping/bending process, and the second contact leg 242 is formed as material sections that protrude from the second clamping leg 240 from the left and right, and that are joined together via a transverse web 243. The transverse web 243 is used to fasten the second clamping spring 24 to the second clamping section 62 of the busbar 6, as illustrated in FIG. 7.

FIG. 6 shows a preassembled unit made up of the first spring-loaded clamping connection 13, the first cover part 3, and the actuating element 5. These components are coupled to one another in a form-fit manner, and are thus held together to form a unit which may then be easily installed in the first main housing part 11. In this case the first clamping spring 14 has a design corresponding to the variant according to FIG. 4.

FIG. 7 shows the operation of connecting the connection module 1 to the plug-in module 2. The second insulation material housing 20 is initially guided along the first insulation material housing 10 via a displacement movement B1. The second insulation material housing 20 is situated at an acute angle relative to the first insulation material housing 10. This acute angle is specified by the shape of the first open space 7. It is apparent that the wall section 260 in the region of the first open space 7 rests against the surface of the first main housing part 11. As the result of a contour 70 that is integrally formed on the first insulation material housing 10, a swivel movement B2 is initiated upon further movement of the second insulation material housing 20 in the direction B1. At the end of the swivel movement, the second side wall 26 is situated essentially in parallel to the first side wall 16. The form-fit coupling between the first insulation material housing 10 and the second insulation material housing 20 is established in this way.

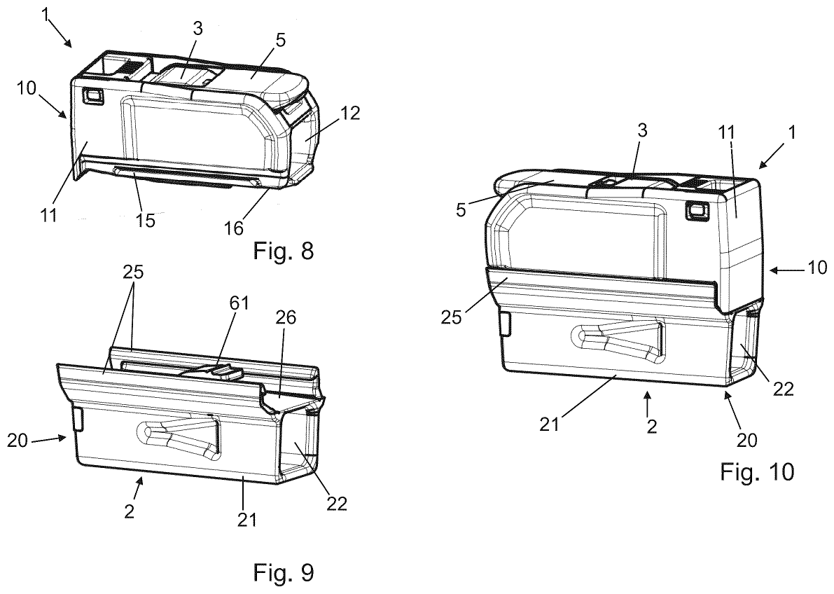

FIG. 8 shows the connection module 1 together with the first insulation material housing 10 and the first form-fit coupling element 15 situated in the region of the first side wall 16. FIG. 9 shows the plug-in module 2 together with the second insulation material housing 20 and the second form-fit coupling element 25 situated in the region of the second side wall 26, and which is associated with the first form-fit coupling element 15 as a mating piece.

FIG. 10 shows the complete lead terminal made up of the connection module 1 and the plug-in module 2 after the assembly operation as explained with reference to FIG. 7. In this case the first form-fit coupling element 15 is no longer visible from the outside, since it is covered by the second form-fit coupling element 25.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lead terminal having a modular design, the lead terminal comprising:
at least one connection module; and
a plug-in module that is separate from the connection module,
wherein the connection module has at least one first spring-loaded clamping connection with a first clamping spring to connect a first electrical conductor via an elastic force, and a first insulation material housing that at least partially encloses the first clamping spring,
wherein the plug-in module has at least one second spring-loaded clamping connection with a second clamping spring to connect a second electrical conductor via elastic force, and a second insulation material housing that at least partially encloses the second clamping spring,
wherein the first insulation material housing has at least one first form-fit coupling element,
wherein the second insulation material housing has at least one second form-fit coupling element that is designed as a mating piece for the first form-fit coupling element so that the second insulation material housing is fastenable to the first insulation material housing via a form-fit coupling between the first form-fit coupling element and the second form-fit coupling element,
the first clamping spring has a first clamping leg for clamping the first electrical conductor to a first clamping point situated in the first insulation material housing, and a first contact leg via which the first clamping spring is supported against the clamping force of the first clamping leg,
wherein the first insulation material housing has a first side wall arranged on a side of the first clamping leg facing away from the first contact leg, and a first opening being arranged in the first side wall,
wherein the second insulation material housing, at a second side wall facing the first side wall, has a second opening that is aligned with the first opening,
wherein the lead terminal has a shared busbar, which in the connected state of the connection module to the plug-in module extends from the first spring-loaded clamping connection through the first and the second openings to the second spring-loaded clamping connection, and
wherein the busbar has a first clamping section, which together with the first clamping leg, forms the first clamping point.

2. The lead terminal according to claim 1, wherein the busbar in the unassembled state of the connection module with the plug-in module is fastened to the connection module or to the plug-in module, and wherein a busbar section extends out of the insulation material housing.

3. The lead terminal according to claim 1, wherein the busbar has a curved section adjoining the first clamping section, in which the busbar merges in a curved manner, directly or via at least one further section of the busbar, into a second clamping section, which with a second clamping leg of the second clamping spring, forms a second clamping point for clamping the second electrical conductor.

4. The lead terminal according to claim 3, wherein the second clamping section is arranged essentially and/or predominantly in parallel to the first clamping section.

5. The lead terminal according to claim 1, wherein the first form-fit coupling element is arranged in the region of the first side wall and/or wherein the second form-fit coupling element is arranged in the region of the second side wall.

6. The lead terminal according to claim 1, wherein the connection module, as a further component, has an actuating element or an actuating lever or a push actuator, via which the first clamping leg is deflectable by manual actuation in order to open the first clamping point.

7. The lead terminal according to claim 1, wherein the first side wall rests against the second side wall, at least in a first subarea.

8. The lead terminal according to claim 1, wherein the second insulation material housing is fastenable to the first insulation material housing by a displacement movement in which the second insulation material housing is displaced at an acute angle relative to the first insulation material housing, and a subsequent swivel movement in which the second side wall is oriented substantially in parallel to the first side wall via the form-fit coupling between the first form-fit coupling element and the second form-fit coupling element.

9. The lead terminal according to claim 1, wherein the first side wall does not rest against the second side wall, at least in a second subarea, and wherein, in the second subarea, a first open space or a wedge-shaped first open space is formed between the first and second side walls.

10. The lead terminal according to claim 1, wherein the first insulation material housing is made up of at least two separate housing parts that are coupleable to one another, and/or the second insulation material housing is made up of at least two separate housing parts that are coupleable to one another.

11. The lead terminal according to claim 1, wherein the first insulation material housing has a first conductor insertion opening for introducing the first electrical conductor, and the second insulation material housing has a second conductor insertion opening for introducing the second electrical conductor, the first conductor insertion opening being arranged on the side of the lead terminal facing away from the second conductor insertion opening.

12. The lead terminal according to claim 1, wherein the first insulation material housing has a first main housing part with an assembly opening for inserting the first spring-loaded clamping connection into the first main housing part, and a first cover part for at least partially closing the assembly opening, the first cover part being insertable into the first main housing part from the side opposite the first side wall.

13. The lead terminal according to claim 1, wherein the second insulation material housing has a second main housing part with an assembly opening for inserting the second spring-loaded clamping connection into the second main housing part, and a second cover part for at least partially closing the assembly opening, the second cover part being insertable into the second main housing part from a side facing away from the second conductor insertion opening.

14. The lead terminal according to claim 13, wherein the second side wall is formed by a wall section of the second main housing part facing the first side wall, and a wall section of the second cover part, the second opening being formed between the wall sections.

15. The lead terminal according to claim 1, further comprising a support contour that protrudes from the second side wall in the direction of the first insulation material housing and that is configured for supporting the busbar and/or for supporting the first insulation material housing on the second insulation material housing is arranged at the second side wall.

16. The lead terminal according to claim 15, wherein the support contour extends through the first opening or at least into the first opening.

17. A modular system for forming different lead terminals that are configurable as needed, the system comprising a plurality of connection modules having the same or different designs, and a plurality of plug-in modules having the same or different designs, a lead terminal of the lead terminals being the lead terminal according to claim 1, wherein a single-pole or multi-pole lead terminal is formed by joining one or more connection modules with one or more plug-in modules of the system, at a user's option.
